(19) United States
(12) Patent Application Publication
(10) Pub. No.: US 2003/0015678 A1
(43) Pub. Date: Jan. 23, 2003

(54) Valve assembly

(75) Inventors: Mitsumasa Kagomoto, Amagasaki-shi (JP); Akira Oi, Amagasaki-shi (JP); Mari Shiotsuki, Amagasaki-shi (JP)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: Kabushiki Kaisha NERIKI

(21) Appl. No.: 10/197,276

(22) Filed: Jul. 16, 2002

(30) Foreign Application Priority Data
Jul. 17, 2001 (JP) P 2001-216058

(51) Int. Cl. F16K 51/00

(52) U.S. Cl. 251/148

(57) ABSTRACT

A housing (5) is formed with a cylinder communication bore (6) able to communicate with an interior space of a gas cylinder (1), a gas passage (7) and a joint attaching portion (8). The joint attaching portion (8) is provided with an engaged portion (21). A joint (14) is attached to the joint attaching portion (8). The joint (14) is provided with a connecting portion (16) to which a gas instrument is connected, a communication passage (18), and an engaging portion (19). The connecting portion (16) is opened to provide an instrument communication bore (17). The instrument communication bore (17) communicates with the cylinder communication bore (6) through the communication passage (18) and the gas passage (7) in order. The engaging portion (19) meshes with the engaged portion (21) unseparably.

### BACKGROUND OF THE INVENTION

1. Field of the Invention

The present invention relates to a valve assembly which is arranged in a gas take-out passage and a gas charging passage of a gas cylinder. More particularly, it concerns a valve assembly which has a portion connecting to a gas utilizing device, a gas charging device and the like, the connecting portion being of a specific structure corresponding to the kind of gas.

2. Explanation of Related Art

As for a gas cylinder which stores liquefied gas such as oxygen gas, carbon dioxide gas and nitrogen gas, there is generally arranged a valve assembly in the gas charging passage or the gas take-out passage. The valve assembly has a housing provided with a cylinder communication bore, a gas passage and a portion connecting to a gas instrument. The connecting portion is provided with an instrument communication bore. The instrument communication bore communicates with the cylinder communication bore via the gas passage. The cylinder communication bore communicates with an interior space of the gas cylinder. The gas passage has a mid portion provided with a valve chamber of an opening-closing valve or the like. The connecting portion adopts a specific structure having a specific outer diameter, thread pitch and the like corresponding to the kind of gas to be stored in the gas cylinder. This prevents such an accident as charging or taking out a different kind of gas by mistake.

Conventionally, the valve assembly of this kind has the housing formed with a joint attaching portion to which a joint is attached and the joint is formed with a portion connecting to a gas instrument so that the connecting portion can be easily set to a specific structure corresponding to the kind of the stored gas. The joint has an interior area formed with a communication passage, through which the instrument communication bore provided in the connecting portion communicates with the gas passage.

As regards the conventional valve assembly, when shipping the gas cylinder provided with this valve assembly, it is sufficient if a joint having a connecting portion which corresponds to the kind of gas is attached to the joint attaching portion. Thus in the case where the valve assembly and the gas cylinder are stocked, it is satisfactory only if plural kinds of joints are stored in correspondence with the kinds of gas. There is no need for stocking the housing of the valve assembly and the gas cylinder in correspondence with the kinds of gas. As a result, this offers an advantage that the stock control for the valve assembly and the gas cylinder attached with this valve assembly is carried out with extreme ease.

However, the joint is attached to the joint attaching portion by screwing threaded portions formed on the joint into the joint attaching portion. This makes it possible to charge a different kind of gas anew into an evacuated gas cylinder or to connect a gas cylinder which stores a different kind of gas to a gas utilizing device, by forcedly loosening the threaded portions to replace the joint. Accordingly, there is a likelihood that improper kind of gas is used.

Then in order to prevent the separation of the joint, it is considered to fix the joint to the joint attaching portion by brazing or the like so as to make it unseparable. However, the brazing work takes much trouble and time to entail a problem of reducing production efficiency. Further, it is considered to form the foregoing connecting portion integrally with the housing. However, this case increases the kind of the valve assembly and that of the gas cylinder attached with this valve assembly, which causes a problem of troublesome stock control.

### SUMMARY OF THE INVENTION

The present invention has an object to provide a valve assembly which has a portion connecting to a gas instrument. The connecting portion can be easily set to a specific structure corresponding to the kind of gas to be stored in a gas cylinder. Besides, once the connecting portion is set to the specific structure, the specific structure is unchangeable.

In order to accomplish the above-mentioned object, the present invention has constructed a valve assembly, for example, as shown in FIGS. 1 to 9.

The valve assembly has a housing 5 formed with a cylinder communication bore 6 which communicates with an interior space of a gas cylinder 1, a gas passage 7 and a joint attaching portion 8. The joint attaching portion 8 is formed with an engaged portion 21. A joint 14 is attached to the joint attaching portion 8. The joint 14 is provided with a portion 16 connecting to a gas instrument, a communication passage 18 and an engaging portion 19. The connecting portion 16 is opened to provide an instrument communication bore 17. The instrument communication bore 17 communicates with the cylinder communication bore 6 via the communication passage 18 and the gas passage 7. The engaging portion 19 meshes with the engaged portion 21 unseparably.

The present invention functions in the following manner, for example, as shown in FIGS. 1 to 9.

The connecting portion to the gas instrument is formed in the joint. There are prepared a plural kinds of joints which have connecting portions in correspondence with the kinds of gas. On the other hand, the housing of the valve assembly provided with the joint attaching portion to which this joint is attached is made common irrespective of the kind of gas. The housing of the common part is attached to the gas cylinder with the joint unattached and it is stocked. When shipping the gas cylinder, the kind of gas to be stored is specified. Therefore, a joint having a connecting portion which corresponds to the kind of gas is attached to the joint attaching portion. Once this joint has been attached to the joint attaching portion, the engaging portion meshes with the engaged portion to make the joint unseparable from the joint attaching portion.

The present invention is constructed and functions as mentioned above. Accordingly, it offers the following advantage.

The joint which has the connecting portion to the gas instrument is attached after the kind of gas to be stored in the gas cylinder has been specified. Therefore, the connecting portion can be easily set to a specific structure corresponding to the kind of gas, which leads to a simplified stock control of the valve assembly and the gas cylinder. In addition, once the joint is attached to the joint attaching portion, it becomes unseparable, so that the structure of the connecting portion cannot be changed. As a result, it is improbable of connecting a gas instrument such as a charging device, a gas utilizing device and the like for a different kind of gas through this valve assembly. In consequence, there is no likelihood that a different kind of gas is charged into an evacuated gas cylinder anew. Further, the present invention prevents erroneous connection of the gas cylinder storing a different kind of gas to a gas utilizing device and therefore can get rid of the fear that improper kind of gas is used.

The engaging portion and the engaged portion may be integrally formed with the joint or with the joint attaching portion. Alternatively, either of the joint attaching portion and the joint may be formed with a retaining portion. The retaining portion holds an engaging member. The engaging member may define the engaging portion or the engaged portion.

The engaging portion may directly mesh with the engaged portion. Or the engaging member is arranged between them and the engaging portion meshes with the engaged portion through this engaging member. In this case, at least one of the joint and the joint attaching portion is formed with a insertion hole which communicates with a gap between the engaging portion and the engaged portion. The engaging member may be inserted from this insertion hole to be guided to a space between the engaging portion and the engaged portion. Listed as concrete examples of the engaging member are a snap ring, a coned disk spring, a spring pin, an engaging pin, a metal wire or the like.

### BRIEF DESCRIPTION OF THE DRAWINGS

FIGS. 1 to 4 show a first embodiment;

FIG. 1 is a schematic diagram view of a gas cylinder to which valve assemblies are attached;

FIG. 2 is a partly broken front view of a valve assembly;

FIG. 3 is a perspective view of a joint;

FIG. 4 shows a modification of the present invention and is a sectional view of the neighborhood of an engaging portion of the valve assembly;

FIG. 5 shows a second embodiment of the present invention. FIG. 5(A) is a vertical sectional view of the neighborhood of a joint attaching portion of a valve assembly. FIG. 5(b) is a sectional view when seen along a line V-V in FIG. 5(a) in a direction indicated by arrows;

FIG. 6 shows a third embodiment and is a vertical sectional view of the neighborhood of a joint attaching portion of a valve assembly;

FIG. 7 shows a fourth embodiment of the present invention and is a vertical sectional view of the neighborhood of a joint attaching portion of a valve assembly just before an engaging member is held by a retaining portion;

FIG. 8 shows a fifth embodiment of the present invention. FIG. 8(a) is a vertical sectional view of the neighborhood of a joint attaching portion of a valve assembly. FIG. 8(b) is a sectional view when seen along a line VIII-VIII in FIG. 8(a) in a direction indicated by arrows; and

FIG. 9 shows a sixth embodiment of the present invention and is a sectional view of the neighborhood of a joint attaching portion of a valve assembly.

### DESCRIPTION OF THE PREFERRED EMBODIMENTS

Hereafter, embodiments of the present invention are explained on the base of the drawings.

(First Embodiment)

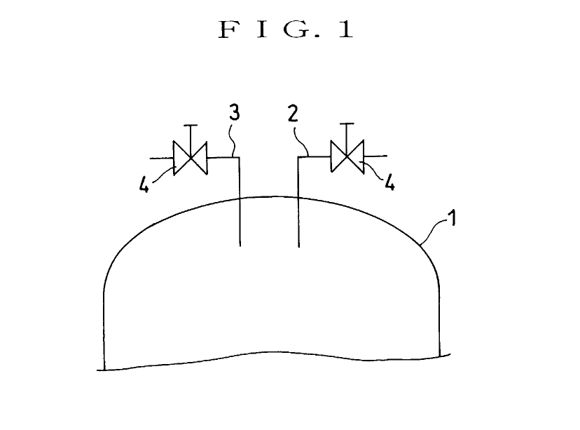

As shown in FIG. 1, a cryogenic gas cylinder 1 stores liquefied gas such as oxygen gas. The cryogenic cylinder 1 has an upper portion provided with a gas take-out passage 2 and a gas charging passage 3. Valve assemblies 4 are attached to the gas take-out passage 2 and the gas charging passage 3, respectively.

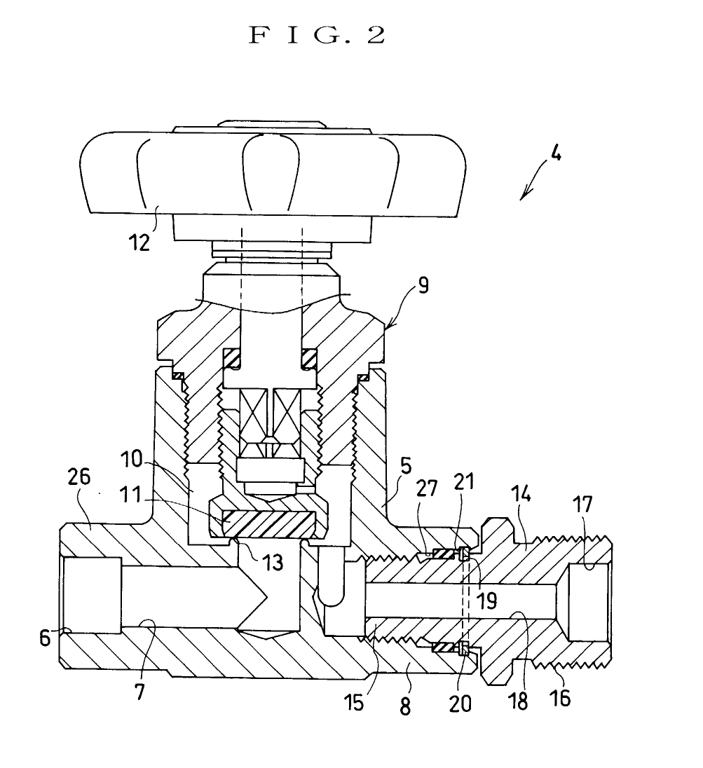

Explanation is given for a concrete structure of the valve assembly 4 attached to the gas take-out passage 2 based on FIGS. 2 and 3 with reference to FIG. 1. Needless to say, the valve assembly 4 attached to the gas charging passage 3 has a similar structure.

As shown in FIG. 2, the valve assembly 4 has a housing 5, from one side of which a connection nozzle 26 projects and from the other side of which a joint attaching portion 8 projects. The connection nozzle 26 is opened to provide a cylinder communication bore 6 and the joint attaching portion 8 is formed with an attaching hole 27. A joint 14 is attached to the attaching hole 27.

The housing 5 has an interior area provided with a gas passage 7, through which the cylinder communication bore 6 mutually communicates with the attaching hole 27. The gas passage 7 has a mid portion formed with a valve chamber 10 of a shut-off valve 9. A closure member 11 is inserted into the valve chamber 10 and is interlockingly connected to an operation handle 12 provided at an upper portion of the housing 5. The closure member 11 approaches or separates from a valve seat 13 by operating the operation handle 12 to open and close the gas passage 7.

When attaching the valve assembly 4 to the gas cylinder 1, the connection nozzle 26 is fixed unseparably to a pipe of the gas take-out passage 2 by, for example, brazing, thereby communicating the cylinder communication bore 6 with an interior space of the gas cylinder 1.

In this embodiment, the cylinder communication bore communicates with the interior space of the gas cylinder through the pipe of the gas take-out passage. However, according to the present invention, for instance, the housing may have a lower portion formed with a leg portion. This leg portion is opened to provide the cylinder communication bore and is fixed to a neck portion of the gas cylinder, thereby directly communicating the cylinder communication bore with the interior space of the gas cylinder.

The joint 14 to be attached to the attaching hole 27 of the joint attaching portion 8 is formed cylindrical as shown in FIG. 3. One of its ends is formed with threaded portions 15 to be screwed into the attaching hole 27. The threaded portions 15 have common shape and structure irrespective of the kinds of gas to be stored in the gas cylinder 1. On the other hand, the other end of the joint 14 is formed with a connecting portion 16 to a gas utilizing device. The connecting portion 16 has a shape and a structure corresponding to the kind of gas to be stored in the gas cylinder 1. In other words, it has a specific outer diameter, thread pitch and the like.

As shown in FIGS. 2 and 3, the connecting portion 16 is opened to provide an instrument communication bore 17. The joint 14 has an interior area formed with a communication passage 18 which extends from the instrument communication bore 17 to a leading end of the threaded portions 15.

Further, the threaded portion 15 has a base end concaved in an outer peripheral surface of the joint 14 to provide an annular engaging groove 19. A snap ring 20 as an engaging member is fitted into the engaging groove 19. The snap ring 20 is formed from a C-shaped spring material and can diametrically expand and contract against its resilient force.

When screwing the threaded portions 15 of the joint 14 into the attaching hole 27, the snap ring 20 is pushed by an inner surface of the attaching hole 27 to diametrically contract. As shown in FIG. 2, the attaching hole 27 has the inner surface concaved to provide an engaged groove 21. When along with the foregoing screw-thread engagement, the snap ring 20 reaches a position where it opposes to the engaged groove 21, the snap ring 20 diametrically expands to its original diameter owing to its resilient force. This enables the engaging groove 19 to mesh with the engaged groove 21 through the snap ring 20 to make the joint 14 unseparable from the joint attaching portion 8. With the joint 14 thus attached, the instrument communication bore 17 communicates with the gas passage 17 within the housing 15 through the communication passage 18.

In the first embodiment, the snap ring as the engaging member is fitted into the engaging portion. However, according to the present invention, it suffices if the engaging member is arranged between the engaging portion and the engaged portion. Therefore, instead, the snap ring or the like engaging member is attached to the engaged portion. Then the joint may be attached to the joint attaching hole like the foregoing embodiment.

The engaging member utilized in the present invention is satisfactory if it can make the engaging portion mesh with the engaged portion. Needless to say, it is not limited to the snap ring employed in the first embodiment.

(Modification)

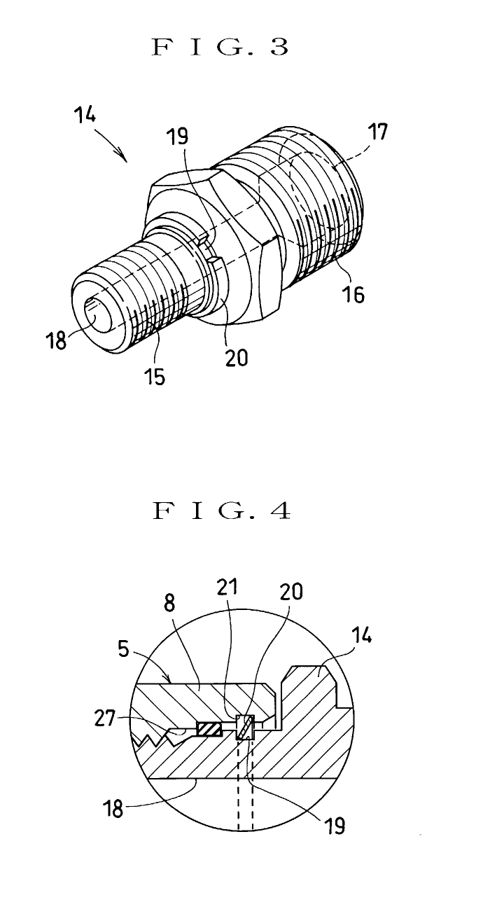

For example, in a modification shown in FIG. 4, a coned disk spring 20 is employed as the engaging member. Also in this case, when screwing the joint 14 into the attaching hole 27, the coned disk spring 20 is pushed by the inner surface of the attaching hole 27 to diametrically contract. When the coned disk spring 20 reaches a position where it opposes to the annular engaged groove 21, it diametrically expands to its original diameter owing to its resilient force. This allows the engaging groove 19 to mesh with the engaged groove 21 via the coned disk spring 20. The coned disk spring 20 may be radially formed with slits or the like so as to facilitate the foregoing diametrical contraction.

(Second Embodiment)

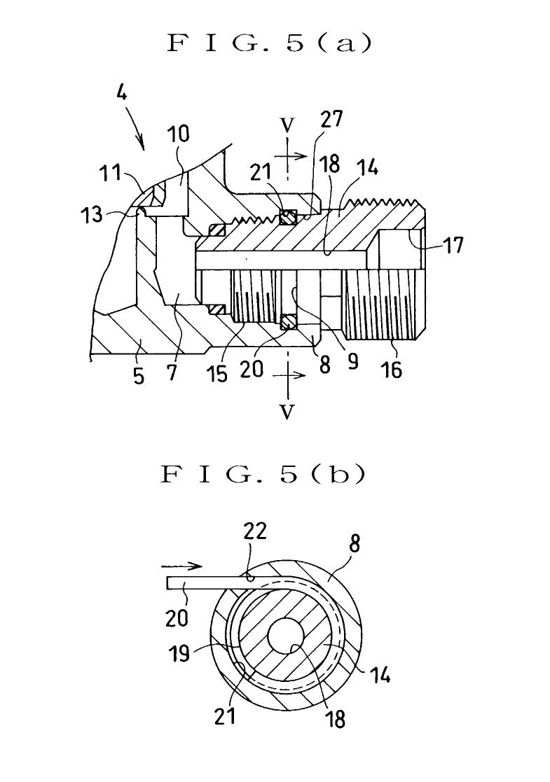

In the first embodiment, before the joint is attached to the joint attaching portion, the engaging member is preliminarily fitted into the engaging portion. However, according to the present invention, like a second embodiment as shown in FIG. 5, after the joint 14 has been attached to the joint attaching portion 8, the engaging member 20 may be arranged between the engaging portion 19 and the engaged portion 21.

More specifically, as shown in FIG. 5(a) and FIG. 5(b), this second embodiment forms the attaching hole 27 in the joint attaching portion 8 of the housing 5. This attaching hole 27 has the inner surface concaved to provide the annular engaged groove 21. And as shown in FIG. 5(b), the joint attaching portion 8 is formed with an insertion hole 22 which extends from an external surface to the engaged groove 21 in a tangent direction.

When the joint 14 is attached to the attaching hole 27 in screw-thread engagement, the annular engaging groove 19 provided by concaving an outer surface of the joint 14 reaches a position where it opposes to the engaged groove 21. In this state, the engaging member 20 made of a metal wire is inserted from the insertion hole 22 to be guided to a gap between the engaging groove 19 and the engaged groove 21. This enables the engaging groove 19 to mesh with the engaged groove 21 through the engaging member 20, thereby making the joint 14 unseparable from the joint attaching portion 8. The engaging member 20 has its terminal end pushed into the insertion hole 22 and therefore cannot be drawn out. The other construction is the same as that of the first embodiment. Accordingly, explanation therefor is omitted.

(Third Embodiment)

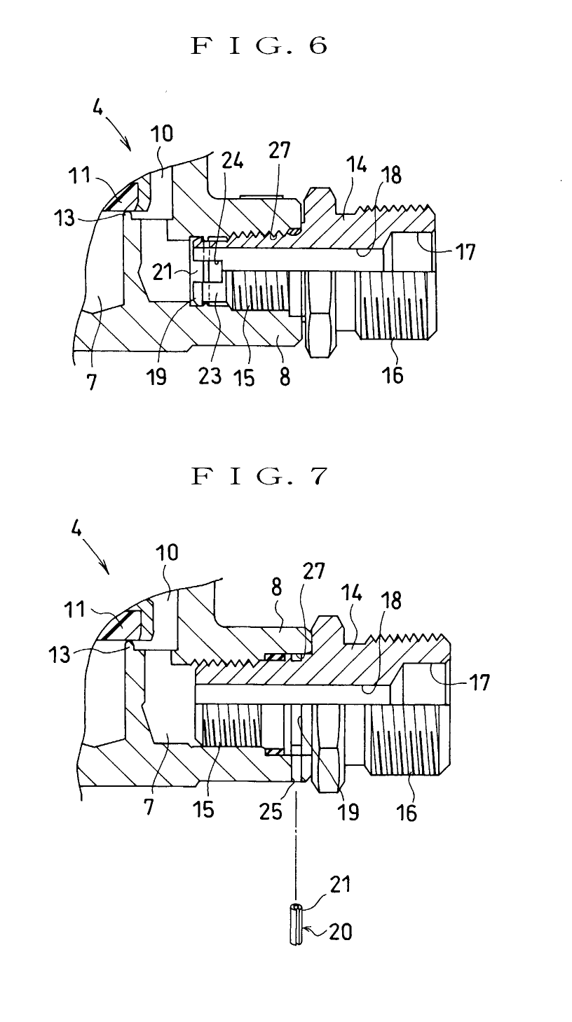

In either of the first and the second embodiments, the engaging portion meshes with the engaged portion through the engaging member. However, like a third embodiment shown in FIG. 6, according to the present invention, the engaging portion may directly mesh with the engaged portion.

More specifically, in this third embodiment, a cylindrical supporting portion 23 extends from a leading end of the threaded portions 15 of the joint 14. The engaging portion 19 made of an annular projection protrudes from an outer peripheral surface of a leading end of the supporting portion 23. The supporting portion 23 is axially formed with a slit 24, thereby enabling the engaging portion 19 at the leading end to diametrically expand and contract.

On the other hand, the joint attaching portion 8 provided in the housing 5 is formed with the attaching hole 27. This attaching hole 27 has a remote inner peripheral surface concaved to provide an annular engaged groove 21.

When screwing the threaded portions 15 of the joint 14 into the attaching hole 27, the engaging portion 19 is going to be pushed by the inner surface of the attaching hole 27 and be diametrically contracted. When the engaging portion 19 reaches a position where it opposes to the engaged groove 21, the engaging portion 19 diametrically expands to its original diameter and meshes with the engaged groove 21. This makes the joint 14 unseparable from the joint attaching portion 8. The other construction is the same as that of the first embodiment. Accordingly, explanation therefor is omitted.

(Fourth Embodiment)

In a fourth embodiment of the present invention shown in FIG. 7, the joint attaching portion 8 provided in the housing 5 is formed, near its leading end, with a retaining portion 25 composed of an insertion hole radially of the attaching hole 27.

On the other hand, the base end of the threaded portions 15 formed in the joint 14 has an outer peripheral surface concaved to provide an annular engaging groove 19. When the joint 14 is attached to the joint attaching portion 8, the retaining portion 25 has its inner end opposed to the engaging groove 19. In this state, a spring pin 20 of the engaging member is pushed into and held by the retaining portion 25. The spring pin 20 has an inner end which forms the engaged portion 21. The engaged portion 21 pushes into the engaging groove 19 and meshes therewith. This makes the joint 14 unseparable from the joint attaching portion 8.

(Fifth Embodiment)

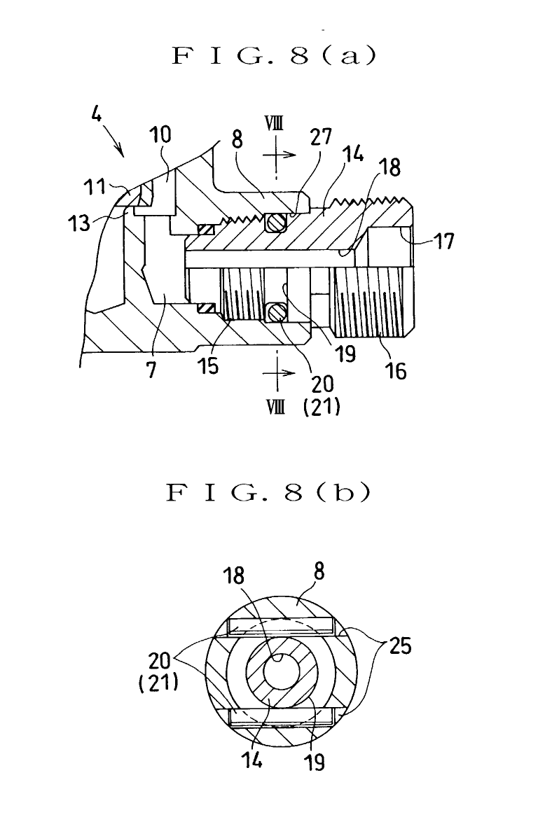

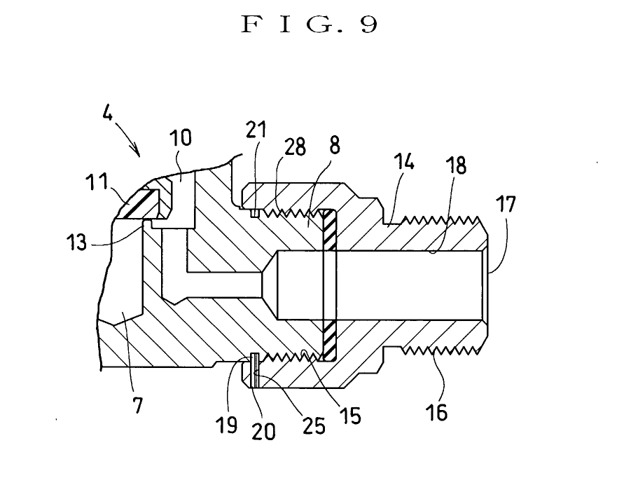

A fifth embodiment of the present invention shown in FIG. 8 provides retaining portions 25 each composed of an insertion hole at two positions on a plane perpendicular to an axis of the attaching hole 27 formed in the joint attaching portion 8 and in a tangent direction with respect to an inner peripheral surface of the attaching hole 27.

On the other hand, the threaded portions 15 formed in the joint 14 have a base end concaved to provide the annular engaging groove 19 like the fourth embodiment. With the joint 14 attached to the joint attaching portion 8, engaging pins 20 of the engaging members are pushed into and held by the retaining portions 25. This engaging pin 20 forms the engaged portion 21, which is fitted into the engaging groove 19 through the push-in to mesh therewith. This makes the joint 14 unseparable from the joint attaching portion 8.

As for the joint attaching portion of each embodiment, explanation is given for a case where its attaching hole is formed with internally threaded portions and the joint is formed with externally threaded portions. However, the joint attaching portion of the present invention is sufficient if the joint can be attached thereto. It is not limited to a specific shape and structure. For instance, the joint attaching portion may be a nozzle formed with externally threaded portions. Alternatively, the joint may be formed into such a structure that it is attached through push-in.

(Sixth Embodiment)

A sixth embodiment shown in FIG. 9 forms externally threaded portions 28 on an outer surface of the joint attaching portion 8. The externally threaded portions 28 have a base end concaved to provide an annular engaged groove 21. On the other hand, one end of the joint 14 is formed with threaded portions 15 which consist of internally threaded portions. There is a wall near a leading end of the threaded portions 15. The retaining portion 25 composed of an insertion hole extends through the wall.

When the joint 14 is attached to the joint attaching portion 8 in screw-thread engagement, the retaining portion 25 has its inner end opposed to the engaged groove 21. In this state, a spring pin 20 of the engaging member is pushed into and held by the retaining portion 25. The spring pin has an inner end which forms the engaging portion 19. The engaging portion 19 pushes into the engaged groove 21. This allows the engaging portion 19 to mesh with the engaged groove 21, thereby making the joint 14 unseparable from the joint attaching portion 8.

In a case where the joint attaching portion is formed with the externally threaded portions and the joint is formed with the internally threaded portions, like the sixth embodiment, for example, the engaging portion is replaced by the engaged portion in shape in the second embodiment and it can be constructed as follows.

The threaded portions of the joint have a leading end in an inner surface of which an annular engaging groove is formed. The externally threaded portions of the joint attaching portion have a base end an outer surface of which is concaved to provide an annular engaged groove. The engaging groove mutually opposes to the engaged groove with the joint attached to the joint attaching portion. And there is provided a insertion hole which extends from an external surface of the joint to a gap between the engaging groove and the engaged groove. The engaging member of a metal wire is inserted from this insertion hole to a space between the engaging groove and the engaged groove.

In the respective embodiments, explanation was made for a valve assembly having the gas passage which is formed at a mid portion with a valve chamber of a shutoff valve. However, the valve assembly of the present invention may have the gas passage provided with a valve chamber of the other kind such as a check valve independently or plural kinds of valve chambers in combination.

Moreover, needless to say, the engaging portion, the engaged portion, the joint and the joint attaching portion are not limited to the shapes and structures of the foregoing embodiments.

What is claimed is:

1. A valve assembly comprising:
a housing (5) provided with a cylinder communication bore (6) able to communicate with an interior space of a gas cylinder (1), a gas passage (7) and a joint attaching portion (8);
an engaged portion (21) provided in the joint attaching portion (8); and
a joint (14) attached to the joint attaching portion (8) and provided with a connecting portion (16) able to connect to a gas instrument, an instrument communication bore (17) formed by opening the connecting portion (16), a communication passage (18), and an engaging portion (19);
the instrument communication bore (17) communicating with the cylinder communication bore (6) via the communication passage (18) and the gas passage (7) in order,
the engaging portion (19) meshing with the engaged portion (21) unseparably.

2. The valve assembly as set forth in claim 1, wherein a retaining portion (25) is formed in the joint attaching portion (8) and an engaging member (20) is held by the retaining portion (25), the engaging member (20) defining the engaged portion (21).

3. The valve assembly as set forth in claim 1, wherein a retaining portion (25) is formed in the joint (14) and holds an engaging member (20), the engaging member (20) defining the engaged portion (19).

4. The valve assembly as set forth in claim 1, wherein an engaging member (20) is arranged between the engaging portion (19) and the engaged portion (21), and the engaging portion (19) meshes with the engaged portion (21) through the engaging member (20).

5. The valve assembly as set forth in claim 4, wherein an insertion hole (22) is formed in the joint attaching portion (8) and communicates with a gap between the engaging portion (19) and the engaged portion (21), the engaging member (20) being inserted from the insertion hole (22) to be guided to a space between the engaging portion (19) and the engaged portion (21).

6. The valve assembly as set forth in claim 4 wherein an insertion hole (22) is formed in the joint (14) and communicates with a gap between the engaging portion (19) and the engaged portion (21), the engaging member (20) being inserted from this insertion hole (22) to be guided to a space between the engaging portion (19) and the engaged portion (21).
